(19) United States
(12) Patent Application Publication
(10) Pub. No.: US 2023/0169392 A1
(43) Pub. Date: Jun. 1, 2023

(54) POLICY DISTILLATION WITH OBSERVATION PRUNING

(71) Applicant: INTERNATIONAL BUSINESS MACHINES CORPORATION, Armonk, NY (US)

(72) Inventors: Subhajit Chaudhury, White Plains, NY (US); Kartik Talamadupula, Snoqualmie, WA (US)

(21) Appl. No.: 17/538,567

(22) Filed: Nov. 30, 2021

(51) Int. Cl. G06N 20/00

(52) U.S. Cl. CPC G06N 20/00

(57) ABSTRACT

Machine learning methods and systems include training a teacher model on an environment. Action scores are generated for actions that can be performed within the environment using the teacher model. A student model is trained using pruned states of the environment. A policy is distilled by retraining the student model using labels from the teacher model and the teacher action scores.

### BACKGROUND

The present invention generally relates to reinforcement learning, and, more particularly, to generalizing learning from text games.

When reinforcement learning systems are trained using text game environments, the trained model can provide good performance when operating within those same environments. However, such models may perform poorly when used in different text game environments, and so generalize poorly.

### SUMMARY

A machine learning method includes training a teacher model on an environment. Action scores are generated for actions that can be performed within the environment using the teacher model. A student model is trained using pruned states of the environment. A policy is distilled by retraining the student model using labels from the teacher model and the teacher action scores.

A machine learning system includes a hardware processor and a memory that stores a computer program. When executed by the hardware processor, the computer program causes the hardware processor to train a teacher model on an environment. Action scores are generated for actions that can be performed within the environment using the teacher model. A student model is trained using pruned states of the environment. A policy is distilled by retraining the student model using labels from the teacher model and the teacher scores.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram that illustrates an exemplary text game environment, with which an agent model can interact to learn a teacher model using reinforcement learning, in accordance with an embodiment of the present invention;

FIG. 2 is a block/flow diagram of a method for performing policy distillation to train a generalized student model from an overfit trained teacher model, in accordance with an embodiment of the present invention;

FIG. 3 is a block diagram of an exemplary neural network architecture of a teacher model that can be trained using reinforcement learning in a training environment, in accordance with an embodiment of the present invention;

FIG. 4 is a block/flow diagram of a method for training a generalized model for navigating within new models that are not accounted for in a training dataset, in accordance with an embodiment of the present invention;

FIG. 5 is a diagram of a simple neural network architecture, in accordance with an embodiment of the present invention;

FIG. 6 is a diagram of a deep neural network architecture, in accordance with an embodiment of the present invention;

FIG. 7 is a block diagram of an exemplary computer architecture that can be used to perform policy distillation and model training, in accordance with an embodiment of the present invention; and

FIG. 8 is a block diagram of a computer program for policy distillation and model training, in accordance with an embodiment of the present invention.

### DETAILED DESCRIPTION

Using a teacher/student model, reinforcement learning systems can be trained to generalize well from one text-based game environment to another. A teacher model may be trained to overfit to the text game(s) that are used for training. A student model may then be trained based on softmax scores provided by the teacher model. Temperature annealing may be used to distill a policy from the teacher model and the student model, and this policy provides superior performance on text games that were not used for training.

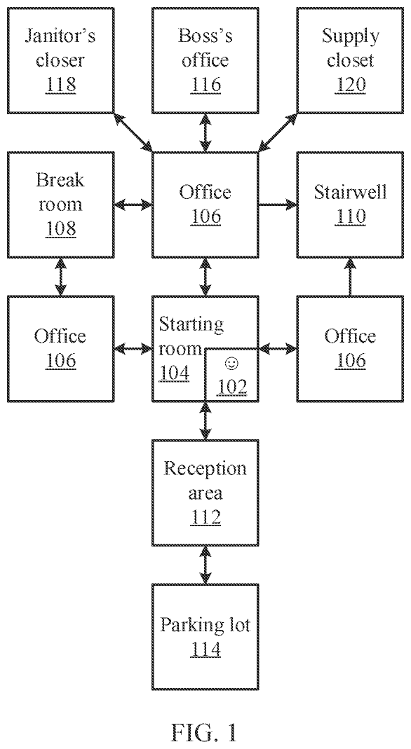

Referring now to FIG. 1, an exemplary text game is shown. As used herein, the term “text game” or “text-based game” refers to an interactive text-based environment. An agent receives information about the environment through text (e.g., English prose) and can issue textual commands to interact with the environment. In some cases, the commands may gather more information about the environment's state (e.g., a “look” command), and in other cases the commands may change the environment's state (e.g., a “take” command). In an example game, the environment may be divided into a set of “rooms,” which an agent 102 can interact with locally. Although shown in a rectilinear grid, the illustrated connections need not reflect any particular spatial relationship.

Thus, an agent 102 is shown in a starting room 104. One action that the agent 102 can perform is to move between rooms. Such transitions may be one-way or two-way, with one-way transitions being areas where the agent 102 can only move from one room to another in a particular direction. As shown, the transitions to the stairwell room 110 from neighboring office 106 may be a one-way transition, whereas other transitions are shown as being two-way. Other rooms that are shown include a break room 108, a reception area 112, a parking lot 114, a boss's office 116, a janitor's closet 118, and a supply closet 120.

As the agent 102 moves from room to room, the text game will provide a textual description of what the agent 102 can perceive within the room. For example, upon entering the break room 108, the text game may describe features of the break room, such as a table, chairs, a coffee machine, a microwave, and a refrigerator. The text game may further provide a description of what other rooms may be reached from the current room. The agent 102 may interact with objects within the room. Such interactions will depend on the game, but exemplary actions include, “take,” “drop,” “look at,” “open,” “close,” and so forth. Thus, an agent 102 in the break room 108 may open the refrigerator, may look inside, and may take an object out of the refrigerator.

The environment itself may be predetermined, for example having been written by a human operator, or may be automatically generated. Using such text games as training data, a reinforcement learning model may be trained to navigate within the environment and to perform tasks.

A reinforcement model is a type of machine learning system that attempts to optimize the agent's actions within an environment toward some goal. This may be represented as a reward value that is associated with the actions. Every time the agent 102 performs an action, a reward value is generated based on the state of the environment. For example, if the goal is to have the agent 102 leave the environment, following the example of FIG. 1, the reward value may be larger if the action moves the agent 102 toward the parking lot 114, while negative values may be assigned to actions that lead the agent farther away from the parking lot 114.

The full reward function may not be available to the agent 102. Thus, as the agent maneuvers through the environment, the reinforcement learning system attempts to learn what actions are associated with high-value rewards. For complex goals, there may be a long chain of actions that are needed to achieve the goal. The reinforcement learning system learns a policy, which determines high-reward actions to take based on the received state of the environment. However, because of the potential complexity of the path needed to reach the goal, the learned model may generalize poorly to other text games, where the reward function may be substantially different and where the learned policy may not provide good results. While training on additional text games may provide greater generality, generality can also be reached by the teacher-student model training described herein.

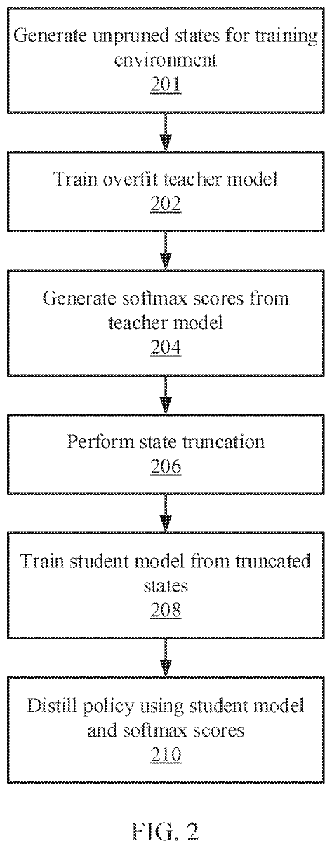

Referring now to FIG. 2, a method of training a reinforcement learning model is shown. Block 201 generates unpruned states for a training environment. Although text environments are described in detail herein, in the form of text games, it should be understood that the present principles may include any appropriate type of environment. These states may be based on, for example, the feedback provided by the environment when the agent 102 performs an action. For example, upon entering a new room, a prose description of the room may be provided, which represents the unpruned state for the room. Upon performing an action within the room, the room may take on a new state.

Block 202 trains an overfit teacher model using the unpruned states. As will be described in greater detail, the teacher model may use a long short term memory (LSTM) encoder and an attention map to generate a context vector from the raw text of the unpruned states. An action scorer generates Q-values for verb and noun action tokens, where verb and noun pair represent an action. In this manner, the various actions that may be taken may be assigned respective softmax scores using the trained teacher model in block 204.

Using these softmax scores, context relevant state truncation can be used in block 206 to performs state truncation. State truncation uses the unpruned states of the environment to create pruned states that focus on verb-noun pairs. These pairs represent the pruned states of the environment, and may be used to improve the generalizability of the model by decreasing the noise of the states.

Block 208 optionally uses the truncated states to train a student model. The student model generates its own set of softmax scores for the actions that may be taken. Block 210 uses the soft labels generated by the teacher model, e.g., the actions with the corresponding softmax score for each respective state. The action probability generated by the student model is learned using the teacher soft scores to obtain a generalized policy by policy distillation on the student model.

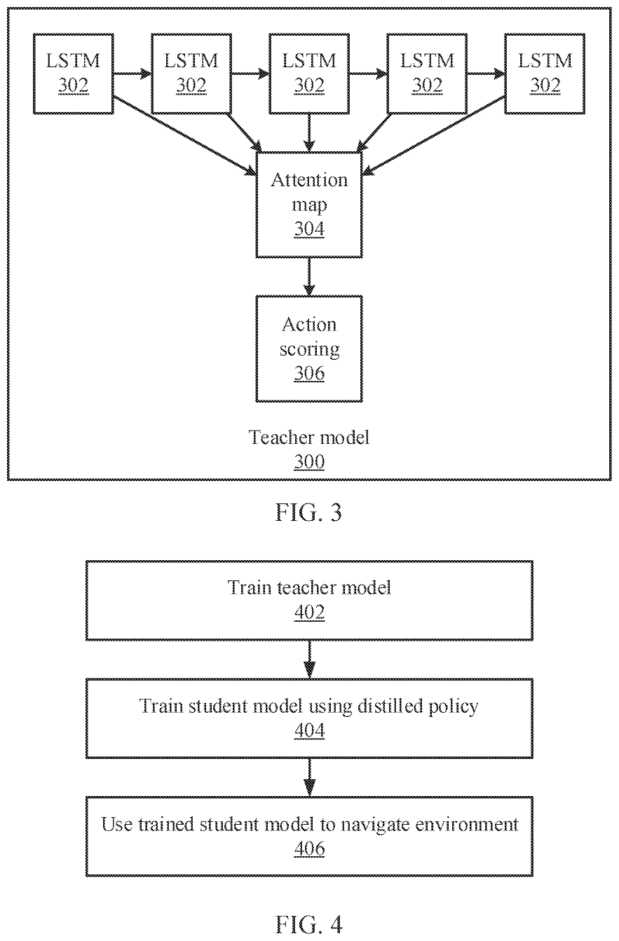

Referring now to FIG. 3, a block diagram of an illustrative teacher model 300 is shown. A series of LSTM layers 302 receive an input, for example as a sequence of words. The input is provided, one word at a time, at the input of the series. The words propagate through the LSTM layers 302, with each layer other than a final layer feeding into a next LSTM layer 302, and with each layer providing an output that is based on a current word being processed as well as previous words.

The outputs of the LSTM are collected by an attention map 304, which generates a context vector. An attention scorer 306 may determine scores for different actions, for example using a softmax function. These actions may include verb/noun pairs.

During training, the model parameters may be updated by optimizing the following loss function:

$${ℒ}_{T} = {‖ Q ( s , a ) - {𝔼}_{s , a} [ r + γ {max}_{{a}^{′}} Q ( s , {a}^{′} ) ] ‖}_{2}$$

where Q(⋅) is a policy function that predicts a reward for performing an action a given a present state s, [symbol] _{s,a} is an expectation value for a state-action pair s, a, γ is a discount factor in the Markov decision process used for reinforcement learning, and a′ is the next step action. As noted above, the teacher model 300 may be trained on the unpruned states of the training text games. The student model may have the same structure as the teacher model 300, or may alternatively have a different internal structure with the same number of outputs.

The teacher model may generate soft labels and hard labels. The soft label predictions give a full probability distribution over all labels. Thus, a vector may be output that includes a set of scores between zero and one, with each value corresponding to a probability of a respective action that may be performed, with the values summing to one. In contrast, a hard label prediction gives a one-hot vector that has a value of one for a most likely action, with every other value in the vector being set to zero. The hard label prediction may be generated from the soft label prediction using by selecting the largest score.

When training the student model, the hard labels from the teacher model 300 may be used, along with soft-predictions generated by the student model itself, to optimize a student loss function. Student loss may be determined as a cross-entropy loss between the student output soft labels and the hard labels from the teacher model 300. Thus, student loss may be expressed as [symbol] ₛ= [symbol] _{ce}(l, x(s)), where [symbol] _{ce} is the cross-entropy loss function, x(s) is output probabilities for the state s by the student model, and where l=argmax(y(s)) is the hard label from the teacher model that is determined from the maximum over the teacher probabilities y(s).

Meanwhile, a distillation loss may be calculated as a cross-entropy loss over soft labels from the teacher model 300 and the student model, with temperature annealing. The distillation loss may be determined as the cross-entropy loss between the student output soft labels and soft labels from the teacher with temperature annealing. Thus, the distillation loss may be expressed as [symbol] _{D}= [symbol] _{CE} (yᵢ^{τ}(s), xᵢ^{τ}(s)), where [symbol] _{CE} is the cross-entropy loss with temperature annealing,

$${x}_{i}^{τ} ( s ) = \frac{{e}^{\frac{{x}_{i} ( s )}{τ}}}{{Σ}_{i} {e}^{\frac{{x}_{i} ( s )}{τ}}}$$

$${y}_{i}^{τ} ( s ) = \frac{{e}^{\frac{{y}_{i} ( s )}{τ}}}{{Σ}_{i} {e}^{\frac{{y}_{i} ( s )}{τ}}}$$

xᵢ(s) is the i^{th} entry of the student output probabilities x(s), and yᵢ(s) is the i^{th} entry of the teacher output probabilities y(s).

Temperature annealing, in a machine learning context, changes the sharpness of a probability distribution, thereby making it sharper for temperature values that are less than 1.0 and flatter for temperature values that a greater than 1.0. This process helps to approximate the global optimum of a function. The use of temperature annealing in the distillation loss matches the flat soft distribution of both the teacher and the student and improves generalization in learning. Using the student loss and the distillation loss, the student model may be trained in block 210.

A total system loss function may be determined, based on the distillation loss [symbol] _{D} and the student loss [symbol] ₛ. For example, the total loss may be determined as:

[symbol]

=w_{verb}(v)[ [symbol] _{D}(y(s,v),x(s,v))+ [symbol] ₛ(lᵥ,x(s,v))]+wₙₒᵤₙ(n)[ [symbol] _{D}(y(s,n),x(s,n))+ [symbol] ₛ(lₙ,x(s,n))]

where w_{verb} is an action verb weight, wₙₒᵤₙ is an action noun weight, v is a verb, n is a noun, v_{T} is an action verb from the teacher model, n_{T} is an action noun from the teacher model, lᵥ and lₙ are hard teacher labels for the verbs and nouns (e.g., lᵥ=argmax(y(s, v)), lₙ=argmax(y(s, n))), and where x(s, n) and y(s, n) denote a probability of verb output probabilities for the student and teacher, respectively.

The weights w_{verb} and wₙₒᵤₙ may be determined for the occurrence of each verb and noun in the teacher model's action trajectory. The teacher actions in an episodic trajectory are divided into sets of verbs and nouns. The frequency of occurrence for each verb and noun is determined from the unpruned state information. The weight of each verb and noun may then be defined as the inverse of the respective verb's or noun's frequency. The structure of the action command is described herein as being (verb,noun), but other structures are possible. For example, action commands may be defined as (verb,adjective,noun). In the event that some other action command is used, then each action component may have a separate set determined, with respective weights. The loss function can similarly be extended with one or more additional terms for the additional components.

As used herein, the term “episode” refers to the collection of steps that starts from a reset state and extends to a final state, which may be defined according to an expiration of a time limit or the achievement of a goal. For example, in a game of chess, the start state of the pieces could be considered a reset state, and each piece movement could be considered an action. The collection of states after each movement and the actions make up an episodic trajectory.

By optimizing the total loss function [symbol] , the parameters of the student model can be updated in block 210. These parameters may be regarded as the weights of the student model. Thus, by finding a collection of weights that minimizes the total loss function [symbol] , the optimal student model weights can be determined.

Referring now to FIG. 4, a method for navigating in an environment using reinforcement learning is shown. Block 402 trains the teacher model 300 as described above, using one or more training environments. Block 404 then uses policy distillation to train the student model, generalizing from the teacher model 300. Block 406 employs the trained student model to navigate a novel environment, which may not have been among the training environments.

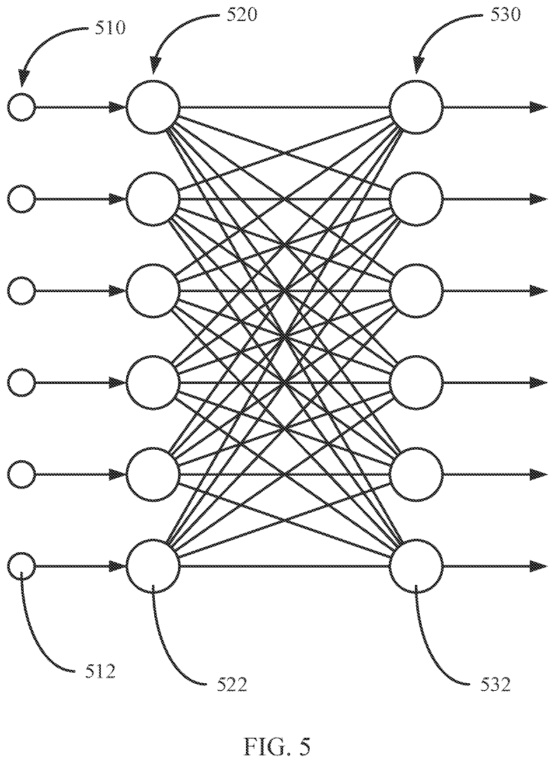

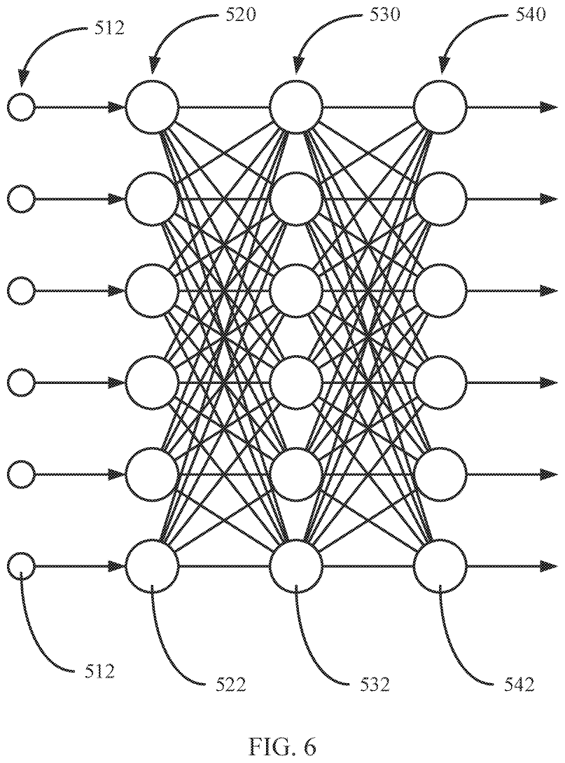

Referring now to FIG. 5, an exemplary neural network architecture is shown. As noted above, the student model and the teacher model 300 may be implemented using artificial neural networks. In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

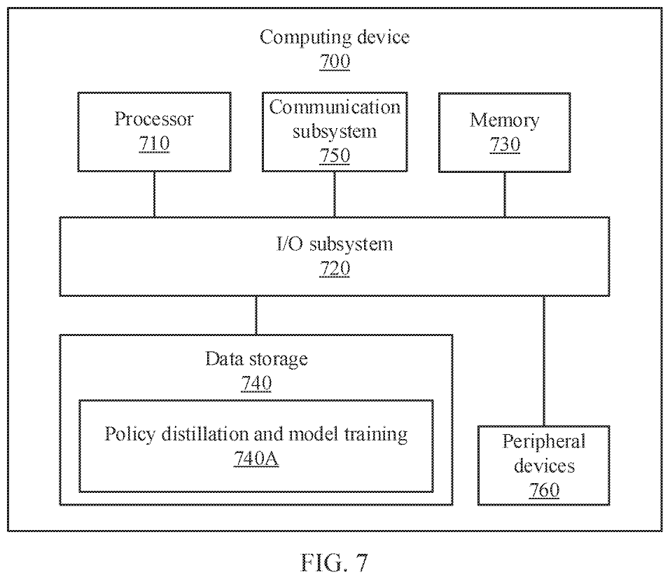

Referring now to FIG. 7, a block diagram shows an exemplary computing device 700, in accordance with an embodiment of the present invention. The computing device 700 is configured to distill a student model policy from a teacher model.

The computing device 700 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 700 may be embodied as a one or more compute sleds, memory sleds, or other racks, sleds, computing chassis, or other components of a physically disaggregated computing device.

As shown in FIG. 7, the computing device 700 illustratively includes the processor 710, an input/output subsystem 720, a memory 730, a data storage device 740, and a communication subsystem 750, and/or other components and devices commonly found in a server or similar computing device. The computing device 700 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 730, or portions thereof, may be incorporated in the processor 710 in some embodiments.

The processor 710 may be embodied as any type of processor capable of performing the functions described herein. The processor 710 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 730 may be embodied as any type of volatile or non-volatile memory or data storage capable of performing the functions described herein. In operation, the memory 730 may store various data and software used during operation of the computing device 700, such as operating systems, applications, programs, libraries, and drivers. The memory 730 is communicatively coupled to the processor 710 via the I/O subsystem 720, which may be embodied as circuitry and/or components to facilitate input/output operations with the processor 710, the memory 730, and other components of the computing device 700. For example, the I/O subsystem 720 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 720 may form a portion of a system-on-a-chip (SOC) and be incorporated, along with the processor 710, the memory 730, and other components of the computing device 700, on a single integrated circuit chip.

The data storage device 740 may be embodied as any type of device or devices configured for short-term or long-term storage of data such as, for example, memory devices and circuits, memory cards, hard disk drives, solid state drives, or other data storage devices. The data storage device 740 can store program code 740A for policy distillation and model training. The communication subsystem 750 of the computing device 700 may be embodied as any network interface controller or other communication circuit, device, or collection thereof, capable of enabling communications between the computing device 700 and other remote devices over a network. The communication subsystem 750 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 700 may also include one or more peripheral devices 760. The peripheral devices 760 may include any number of additional input/output devices, interface devices, and/or other peripheral devices. For example, in some embodiments, the peripheral devices 760 may include a display, touch screen, graphics circuitry, keyboard, mouse, speaker system, microphone, network interface, and/or other input/output devices, interface devices, and/or peripheral devices.

Of course, the computing device 700 may also include other elements (not shown), as readily contemplated by one of skill in the art, as well as omit certain elements. For example, various other sensors, input devices, and/or output devices can be included in computing device 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

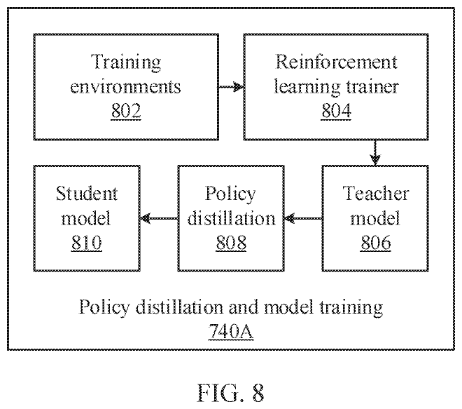

Referring now to FIG. 8, additional detail on the policy distillation and model training 740A is shown. A set of training environments 802 are used by reinforcement learning trainer 804 to train a teacher model 806. Because the training environments 802 may be limited relative to the full diversity of possible environments that may be encountered, the teacher model 806 may overfit to these training environments 802. Policy distillation 808 therefore trains the student model 810 using the teacher model 806, providing a student model that can more effectively generalize to unseen environments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented machine learning method, comprising:
training a teacher model on an environment;
generating action scores for actions that can be performed within the environment using the teacher model;
training a student model using pruned states of the environment; and
distilling a policy by retraining the student model using labels from the teacher model and the teacher action scores.

2. The method of claim 1, wherein training the teacher model includes extracting unpruned states from the environment.

3. The method of claim 2, further comprising truncating the unpruned states to generate pruned states.

4. The method of claim 3, wherein the pruned states include verb-noun pairs.

5. The method of claim 1, wherein distilling the policy includes performing temperature annealing.

6. The method of claim 1, wherein training the teacher model includes determining weight values of the student model that minimize a loss function, wherein the loss function includes a policy function that predicts a reward for performing an action given a present state and an expectation value for a state-action pair.

7. The method of claim 1, wherein the teacher model includes a series of long short-term memory neural network layers.

8. The method of claim 7, wherein the student model has a same neural network structure as the teacher model.

9. The method of claim 1, wherein the environment is a text game and the actions include commands that an agent can perform within the text game.

10. The method of claim 1, further comprising navigating through a new environment using actions determined by the retrained student model.

11. A computer program product for machine learning, the computer program product comprising a computer readable storage medium having program instructions embodied therewith, the program instructions executable by a hardware processor to cause the hardware processor to:
train a teacher model on an environment;
generate action scores for actions that can be performed within the environment using the teacher model;
train a student model using pruned states of the environment; and
distill a policy by retraining the student model using labels from the teacher model and the teacher action scores.

12. The computer program product of claim 11, wherein the program instructions further cause the hardware processor to extract unpruned states from the environment.

13. The computer program product of claim 12, wherein the program instructions further cause the hardware processor to truncate the unpruned states to generate pruned states.

14. The computer program product of claim 13, wherein the pruned states include verb-noun pairs.

15. The computer program product of claim 11, wherein the program instructions further cause the hardware processor to perform temperature annealing.

16. The computer program product of claim 11, wherein the program instructions further cause the hardware processor to determine weight values of the student model that minimize a loss function, wherein the loss function includes a policy function that predicts a reward for performing an action given a present state and an expectation value for a state-action pair.

17. The computer program product of claim 11, wherein the teacher model includes a series of long short-term memory neural network layers.

18. The computer program product of claim 17, wherein the student model has a same neural network structure as the teacher model.

19. The computer program product of claim 11, wherein the environment is a text game and the actions include commands that an agent can perform within the text game.

20. A machine learning system, comprising:
a hardware processor; and
a memory that stores a computer program, which, when executed by the hardware processor, causes the hardware processor to:
train a teacher model on an environment;
generate action scores for actions that can be performed within the environment using the teacher model;
train a student model using pruned states of the environment; and
distill a policy by retraining the student model using labels from the teacher model and the teacher action scores.
